(19) United States
(12) Patent Application Publication
(10) Pub. No.: US 2025/0046503 A1
(43) Pub. Date: Feb. 6, 2025

(54) COOLING ASSEMBLY AND TRANSFORMER

(71) Applicant: Delta Electronics (Thailand) Public Co., Ltd., Samutprakarn (TH)

(72) Inventors: Hugues NJIENDE, Paderborn (DE); Mario WINNER, Dortmund (DE)

(21) Appl. No.: 18/784,940

(22) Filed: Jul. 26, 2024

(30) Foreign Application Priority Data
Aug. 2, 2023 (EP) 23189248.0

(51) Int. Cl. H01F 27/02; H01F 27/22

(52) U.S. Cl. CPC H01F 27/025; H01F 27/22

(57) ABSTRACT

Provided is a cooling assembly for a magnetic component, comprising at least one magnetic core comprising a body portion and a plurality of leg portions extending from the body portion along a leg extension direction; at least one winding wound around at least one of said leg portions as a winding leg portion of the magnetic core; and a chassis configured to house the at least one magnetic core and the at least one winding, wherein the chassis comprises at least one heat sink portion adjacent to at least one of the at least one winding, and the at least one heat sink portion comprises a shape, at least in cross-section perpendicular to the leg extension direction, corresponding at least to a shape of an adjacent portion of the adjacent at least one winding. The present disclosure further concerns a magnetic component comprising said cooling assembly.

### CROSS-REFERENCE TO RELATED APPLICATIONS

This application claims priority to European Patent Application No. 23189248.0, filed on Aug. 2, 2023, which is hereby incorporated by reference in its entirety.

### TECHNICAL FIELD

The present disclosure concerns a cooling assembly, especially for magnetic component such as a transformer or a choke or an inductor. The present disclosure further concerns a magnetic component comprising a cooling assembly.

### BACKGROUND

Common magnetic components, known from for example US 2019/0019610 A1, referred to as “magnetic element” therein, comprise magnetic cores or magnetic core elements formed of ferrite and winding wound around columns (also referred to as leg portions) of the magnetic core elements. Therein, components of the magnetic cores, for example the columns thereof, are shaped so as to accommodate the winding. For example, as shown in FIG. 6 of US 2019/0019610 A1, columns of the shown magnetic element are formed in an arc shape to accommodate the winding.

Furthermore, CN103730230A also shows a magnetic core with columns (leg portions) shaped so as to accommodate a winding.

Commonly, as cooling assemblies, such magnetic components are housed and potted in a chassis. Such chassis are commonly rectangular and contact outer surfaces of the magnetic cores for cooling thereof.

However, commonly known chassis have a drawback in that distances between inner portions of the magnetic cores, for example leg portions thereof, and especially between the windings, and inner surfaces of the chassis are large, thereby providing inadequate cooling of the magnetic cores and/or windings. In other words, their thermal resistance is high. Furthermore, a total volume of the chassis is large, thereby increasing the size of the cooling assembly and increasing material costs for the chassis and for the large amount of potting material necessary to fill the volume of the chassis.

### SUMMARY

One of the objects of the present disclosure is to provide a cooling assembly which overcomes these deficiencies. In particular, some of the objects of the present disclosure are to provide a cooling assembly with a high thermal efficiency, a compact size, and reduced material costs. Another object is to provide a transformer with these advantages, in particular to provide a transformer with high efficiency.

Solutions to these objects are achieved by the subject matter of the independent claim. The dependent claims contain advantageous embodiments of the present disclosure.

In particular, solutions to these objects are achieved by a cooling assembly, especially for a magnetic component, according to claim 1. A magnetic component is for example a transformer, a choke, an inductor or the like. The cooling assembly comprises at least one magnetic core, wherein the magnetic core comprises a body portion and a plurality of leg portions extending from the body portion along a leg extension direction. Further, the cooling assembly comprises at least one winding wound around at least one of said leg portions. Said leg portion(s) is/are thus also referred to as “winding leg portion” of the magnetic core or of the cooling assembly. The cooling assembly also comprises a chassis. Therein, the chassis is configured to house the at least one magnetic core and the at least one winding. The chassis comprises at least one heat sink portion adjacent to at least one of the at least one winding. The at least one heat sink portion comprises a shape, at least in cross section perpendicular to the leg extension direction, corresponding at least to a shape of an adjacent portion of the adjacent at least one winding.

Thereby, the cooling assembly of the present disclosure comprises a chassis which, via the at least one heat sink portion provided adjacent to and corresponding in shape with an adjacent portion of the winding, is provided with a reduced distance to the winding and/or at least a leg portion of the magnetic core, thereby providing reduced thermal resistance, i.e. improved cooling, and a lower total volume of the cooling assembly.

For simplicity and ease of understanding, unless otherwise specified or implicit, when referring to for example “the winding”, “the leg portion”, “the heat sink portion”, etc. in the singular form, this refers to configurations of one or more of the respective elements.

In the foregoing and in the following, a shape corresponding at least to a shape of an adjacent portion of the adjacent at least one winding is referred to. This will now be explained in more detail. For instance, the cooling assembly comprises a plurality of windings, the magnetic core comprising a plurality of leg portions each being wrapped by respectively one or more of the windings. The cooling assembly comprises for example a plurality of heat sink portions, wherein each of the heat sink portions is adjacent to one or more windings. Each of these adjacent windings thus comprises a winding portion, i.e. a portion of winding, which is adjacent to said heat sink portion. The heat sink portion comprises a shape which corresponds at least to a shape of the adjacent winding portion(s). Furthermore, the heat sink portion's shape may additionally correspond to a shape of other elements of the cooling assembly, for example may additionally correspond to a shape of an adjacent leg portion, in particular an adjacent portion of the adjacent leg portion. One heat sink portion may comprise a shape corresponding to shape of multiple adjacent winding portions, in particular to fit between the multiple adjacent winding portions. In general, it is possible that not all winding portions are adjacent to a heat sink portion.

In the foregoing and in the following, the term “adjacent” means “closest to”. For instance, if the cooling assembly comprises a plurality of windings, the “adjacent winding portion adjacent to the heat sink portion” means a portion of one of the windings closest to the heat sink portion, wherein the winding is the winding closest to the heat sink portion and the adjacent winding portion is a portion of that winding closest to the heat sink portion. There may be more than one, especially two, windings adjacent to one heat sink portion, wherein their respective distances to the shaped portion are roughly equal. In particular, no other windings or portions of the magnetic core are disposed between the shaped portion and its adjacent winding(s). Further, “closest to” is with regard to a direction perpendicular to the leg extension direction.

In the foregoing and in the following, the term “one shape corresponds to another shape” especially means that the one shape is configured so as to at least partially accommodate the another shape. In particular, said term can mean that the shapes match each other, as will be apparent from embodiments of the present disclosure. For instance, when one shape is quarter-circular convex, then the matching shape thereto would be quarter-circular concave, and vice versa. In some embodiments, the term “one shape corresponds to another shape” means that curvatures of the shapes are equal to one another, especially with opposing radiuses.

In particular, in certain embodiments, the at least one heat sink portion is disposed in close proximity to the adjacent winding. Herein, the term “close proximity”, especially “close”, refers to a spacing between the two elements being as small as possible without the two elements contacting one another. Alternatively, “close proximity” refers to the adjacent winding at least in part contacting the respective heat sink portion. For example, in cases in which a winding is formed by wrapping of a(n) (insulated) wire, an outer surface of the total winding may not be perfectly flat, with some wires being radially further outward than others. In such cases, at least one portion of the wires may contact the heat sink portion.

In one embodiment, the spacing between the at least one heat sink portion and the adjacent winding is filled with filler material such as potting or thermal grease or thermal glue.

The chassis and the magnetic core of the cooling assembly are separate elements. In particular, the chassis is configured so as to not substantially conduct or close a magnetic circuit generated by the winding(s) of the cooling assembly. In other words, the chassis is configured to cool the magnetic core, but is not configured as part of the magnetic circuit. In particular, materials of the magnetic core and the chassis are different from each other. For example, the magnetic core consists of or comprises a material having a high magnetic permeability (μr substantially more than 1), whereas the chassis consists of or comprises a material having a low magnetic conductivity (μr near 1, especially less than 2). For example, the magnetic core consists or comprises of a ferrite, and the chassis comprises or consists of copper or aluminum or ceramic material.

In one embodiment, the at least one heat sink portion comprises at least one concave surface corresponding respectively to the shape of the adjacent portion of the at least one winding adjacent thereto. In particular, the concave shape corresponds to or matches with a convex shape of the adjacent winding portion. In one embodiment, the concave shape of the heat sink portion is configured to at least partially accommodate the adjacent winding portion. The concave shape is rounded.

In some embodiments, the respective concave surface is half-circular or quarter-circular. Therein, the respective concave surface is correspondingly configured to at least partially accommodate a half-circular or quarter-circular shaped adjacent winding portion.

In one embodiment, the magnetic core comprises three leg portions. Therein, at least a middle leg portion of the three leg portions is a winding leg portion. Said winding leg portion is rounded or comprises rounded edges. In one embodiment, the winding leg portion is circular, oval, stadium-shaped, or rectangular with rounded edges. In one embodiment, the shape of the winding corresponds to the shape of the winding leg portion.

In one embodiment, all leg portions may be winding leg portions. Alternatively, some leg portions may be winding leg portions and at least one further leg portion may be a return leg portion not comprising winding wound around it.

In some embodiments, the chassis comprises two heat sink portions adjacent to the winding of the middle leg portion. Therein, each of the two heat sink portions comprises a quarter-circular shaped surface so as to, especially taken together, substantially correspond to the shape of the adjacent portion of the winding and/or the middle leg portion. In one embodiment, the two heat sink portions are not connected together and/or are not in contact with one another such that their quarter-circular shaped surfaces each correspond to a quarter-circular adjacent portion of the respectively adjacent winding. In some special embodiments, the two heat sink portions may be connected together, such that they in common comprise a half-circular shaped surface corresponding to a half-circular adjacent portion of the winding adjacent to them.

In some embodiments, the chassis comprises one heat sink portion adjacent to the winding of the middle leg portion. The heat sink portion therein comprises a half-circular shaped surface so as to substantially correspond to the shape of the adjacent portion of the winding and/or the middle leg portion.

In one embodiment, the at least one magnetic core, especially respectively, comprises a plurality of winding leg portions. Therein, at least one heat sink portion is disposed respectively between, perpendicular to the leg extension direction, two adjacent winding leg portions. In other words, along a direction perpendicular to the leg extension direction, two winding leg portions and their respective windings sandwich at least one heat sink portion.

One of the directions perpendicular to the leg extension direction is defined as a height direction. The other one of the directions perpendicular to the leg extension direction is defined as a width direction. Therein, the leg extension direction, the height direction, and the width direction together define a Cartesian coordinate system, i.e. are all perpendicular to one another. The width direction and the height direction lie in a plane which defines the cross section of the leg portions of the magnetic core.

In one embodiment, the at least one magnetic core, especially respectively, comprises three winding leg portions with respective windings, wherein at least two heat sink portions are provided, respectively disposed between two of the three winding leg portions.

In some embodiments, the at least one heat sink portion disposed between two adjacent winding leg portions comprises two concave surfaces each comprising a quarter-circular shaped surface corresponding to the respective adjacent winding leg portion and/or to the respective adjacent winding of the respective adjacent winding leg portion.

In one embodiment, the chassis further comprises a body portion having a substantially rectangular shape. In some embodiments, the substantially rectangular shape of the body portion is configured to accommodate outer surfaces of the at least one magnetic core, specifically the body portion(s) thereof.

In some embodiments, the body portion and the at least one heat sink portion are separate elements. In particular, the body portion and the at least one heat sink portion are not monolithic with one another. In one embodiment, the at least one heat sink portion is fixed or attached to the body portion. For example, the at least one heat sink portion may be glued, soldered and/or screwed to the body portion. Further, the at least one heat sink portion may be held in place via potting material or thermal glue of the cooling assembly. In some embodiments, the separate heat sink portion(s) is/are a separate heat sink disposed within the chassis.

In some embodiments, the body portion and the at least one heat sink portion are formed integrally with one another. In particular, the body portion and the at least one heat sink portion are formed monolithically with one another. For example, the body portion and the at least one heat sink portion may be an integral monolithic part of the chassis. In one embodiment, in such cases, the multiple integral heat sink portions may be defined as one single heat sink portion, especially comprising one or more shaped surfaces, for example one or more quarter-circular or half-circular surfaces.

Advantageously, the chassis, especially the at least one heat sink portion, comprises or consists of a paramagnetic material. For example, the chassis is formed of aluminum or ceramic material. In one embodiment, the body portion and the heat sink portion are formed of the same material, especially aluminum or ceramic material also in the case of these being formed as separate elements.

In one embodiment, the chassis of the cooling assembly comprises a plurality of heat sink portions, each having one or more of the foregoing and following configuration examples. In particular, the foregoing and following configuration examples are combinable, such that one or more heat sink portions has a different configuration than one or more other heat sink portions. For instance, as will also be apparent from the embodiments, some heat sink portions may be formed integrally, especially monolithically, with the body portion of the chassis, whereas other heat sink portions may be formed separate therefrom, i.e. not integrally/monolithically therewith.

In one embodiment, the at least one magnetic core comprises at least one return leg portion as one of the leg portions. Therein, at least one of the return leg portions comprises a shape corresponding to the shape of the winding leg portion(s) and/or the winding thereof adjacent to said return leg portion. In one embodiment, at least one of the return leg portions comprises, at least in cross section perpendicular to the leg extension direction, a concave shaped surface which corresponds to the shape of the winding leg portion(s) and/or to the winding thereof adjacent to said return leg portion.

In one embodiment therein, the shape of said return leg portion(s) comprising the concave shaped surface is arranged opposed, perpendicular to the leg extension direction, to the at least one heat sink portion of the chassis. In other words, said return leg portion(s) comprises a portion with a shape similar to that of at least one heat sink portion of the chassis and is arranged opposed thereto. In one embodiment, said return leg portion(s) including the concave surface is disposed between two winding leg portions and the respective adjacent winding portions thereof and includes two concave surfaces. In one embodiment, said return leg portion(s) including the concave surface is disposed between two winding leg portions and the respective adjacent winding portions thereof and includes four concave surfaces. In particular, one of said return leg portion(s) is arranged, together with one of the heat sink portion(s) of the chassis, between two adjacent winding legs or between an adjacent winding leg and the body portion of the chassis. The heat sink portion(s) oppose the return leg portion(s) and vice versa along a height direction perpendicular to the leg extension direction. In other words, said return leg portion and said heat sink portion are both sandwiched by two adjacent winding legs and their windings or sandwiched by the body portion of the chassis and an adjacent winding leg and its winding.

In one embodiment, the chassis includes a plurality of cooling channels. The cooling channels are formed in the at least one heat sink portion of the chassis.

In some embodiments, the body portion and/or at least one heat sink portion of the chassis comprises one or more cooling channels. Preferably, the cooling channel(s) extend(s) longitudinally along the leg extension direction.

In one embodiment, the cooling assembly further comprises potting material or thermal glue. The potting material or thermal glue fills the chassis, especially a cavity thereof comprising gaps between the other elements of the cooling assembly.

The present disclosure also concerns a magnetic component comprising at least one cooling assembly according to any one of the foregoing described configurations. Examples of magnetic components are a transformer or a choke or an inductor. In one embodiment, the at least one winding is a part of or constitutes a primary winding, a secondary winding, or a choke winding of the magnetic component.

### BRIEF DESCRIPTION OF DRAWINGS

Further details, advantages, and features of the embodiments of the present disclosure are described in detail with reference to the figures. Therein:

FIG. 1 shows a schematic cross sectional view of a cooling assembly according to a first embodiment of the present disclosure.

FIGS. 2a, 2b show schematic cross sectional views of a cooling assembly according to a second embodiment of the present disclosure.

FIG. 3 shows a schematic cross sectional view of a cooling assembly according to a third embodiment of the present disclosure.

FIG. 4 shows a schematic cross sectional view of a cooling assembly according to a fourth embodiment of the present disclosure.

FIG. 5 shows a schematic cross sectional view of a cooling assembly according to a fifth embodiment of the present disclosure.

FIG. 6 shows a schematic cross sectional view of a cooling assembly according to a sixth embodiment of the present disclosure.

FIG. 7 shows a schematic cross sectional view of a cooling assembly according to a seventh embodiment of the present disclosure.

FIG. 8 shows a schematic cross sectional view of a cooling assembly according to an eighth embodiment of the present disclosure.

FIG. 9 shows a schematic cross sectional view of a cooling assembly according to a ninth embodiment of the present disclosure.

FIG. 10 shows a schematic cross sectional view of a cooling assembly according to a tenth embodiment of the present disclosure.

FIG. 11 shows a schematic cross sectional view of a cooling assembly according to an eleventh embodiment of the present disclosure.

FIG. 12 shows a schematic cross sectional view of a cooling assembly according to a twelfth embodiment of the present disclosure.

FIG. 13 shows a schematic cross sectional view of a cooling assembly according to a thirteenth embodiment of the present disclosure.

FIG. 14 shows a schematic cross sectional view of a cooling assembly according to a fourteenth embodiment of the present disclosure.

FIG. 15 shows a schematic cross sectional and perspective view of a magnetic core of the cooling assembly according to embodiment thirteen or fourteen of the present disclosure.

FIG. 16 shows a schematic exploded view of the cooling assembly according to embodiment thirteen of the present disclosure.

FIG. 17 shows a schematic exploded view of the cooling assembly according to embodiment fourteen of the present disclosure.

FIG. 18 shows a schematic cross sectional view of a cooling assembly according to a fifteenth embodiment of the present disclosure.

FIG. 19 shows a schematic circuit diagram of an embodiment of a transformer comprising the cooling assembly according to any one of the embodiments.

### DESCRIPTION OF EMBODIMENTS

FIG. 1 shows a schematic cross sectional view of a cooling assembly 1 according to a first embodiment of the present disclosure.

The cooling assembly 1 comprises at least one magnetic core 20. Although presently not shown in the cross sectional view of FIG. 1, the at least one magnetic core 20 comprises a body portion 21 (see for example FIG. 15). Furthermore, as can be seen from FIG. 1, the at least one magnetic core comprises a plurality of leg portions 22. The leg portions 22 are connected to the body portion 21 and extend therefrom along a leg extension direction 2.

Furthermore, the cooling assembly 1 comprises a winding 3 with a predetermined winding number wound around at least one of said leg portions 22. In the present embodiment, the cooling assembly 1 comprises one winding 3. The leg portion 22 around which the winding 3 is wound is also referred to as a winding leg portion 23 of the magnetic core 20. The leg portions 22 which do not comprise a winding 3 wound around them are also referred to as return leg portions 25. The return leg portions 25 essentially close a magnetic circuit formed via induction of the winding 3 in the winding leg portion 23 together with the body portion 21.

The cooling assembly 1 further comprises a chassis 30 configured to house the magnetic core 20 and the winding 3. As is apparent from the figures, the chassis 30 is a separate element with regard to the magnetic core 20 and the winding 3.

The chassis 30 comprises at least one heat sink portion 31, in the present embodiment two heat sink portions 31, adjacent to at least one of the at least one winding 3. In the present embodiment, the chassis 30 comprises two heat sink portions 31, both of which are adjacent to the one winding 3.

Each of the heat sink portions 31 comprises a surface 32 with a shape, at least in cross-section perpendicular to the leg extension direction 2, i.e. in the cross sectional view of FIG. 1, corresponding at least to a shape of an adjacent portion 4 of the adjacent at least one winding 3. In the present embodiment, the surface 32 is a concave surface 32. In other words, in the present embodiment, each of the heat sink portions 31 comprises a shape which corresponds to a shape of a portion 4 of the winding 3 which is adjacent to the respective heat sink portion 31. In the present embodiment, the winding 3 is substantially oval-shaped or stadium-shaped, and the corresponding adjacent portion 4 of said winding 3 has a quarter-circular shape.

Due to the heat sink portions 31 of the chassis 30 having a concave shaped surface 32 corresponding to the shape of the adjacent portion 4 of the winding 3, the heat sink portions 31 can be brought into close proximity around the winding 3.

In this regard, the term “close proximity” refers to a distance between the winding 3 and the heat sink portion 31 being equal to or greater than a required insulation distance for electric insulation thereof, but also as small as possible without the two elements contacting one another. Thereby, the chassis is provided with a reduced distance to the winding 3 and/or the leg portions 22 of the magnetic core, which provides improved cooling and a lower total volume of the cooling assembly 1.

Furthermore, as shown in FIG. 1, the return leg portions 25 also comprise a concave shape, in particular a concave surface 26, which corresponds to the shape of the winding leg portion 23 and the winding 3 thereof adjacent to the respective return leg portion 25. Furthermore, the respective shape of the return leg portions 25 is similar to the shape of the heat sink portions 31. Therein, the return leg portions 25 are arranged opposed to the heat sink portions 31 of the chassis 30. In this regard, as is apparent from FIG. 1, the term “similar to the shape” with regard to the return leg portions 25 in view of the heat sink portions 31 means that the shape of the return leg portions 25 is generally of a similar or same shape as that of the heat sink portions 31 with larger dimensions especially along a height direction 5 perpendicular to the leg extension direction 2. In particular, the return leg portions 25 comprise the concave surface 26 along with a straight portion 27 extending therefrom along the height direction 5 towards the heat sink portions 31 of the chassis 30.

Thereby, the return leg portions 25 can be brought into close proximity with the winding 3 and the winding leg portion 23 as well as the heat sink portions 31 of the chassis 30 for improved cooling and lower total volume of the cooling assembly 1.

Furthermore, the chassis 30 comprises a body portion 33, which in the present embodiment has a substantially rectangular shape. In particular, the body portion 33 of the present embodiment has a half-rectangular shape. Although not shown, the chassis 30 may further comprise a lid portion which is placed, along the height direction 5, on top of the body portion 33, so as to close off the chassis 30, the chassis 30 thus having a full-rectangular shape, for example. Such a lid portion may be formed by, for example, a base plate which comprises a printed circuit board (PCB).

In the present embodiment, the heat sink portions 31 and the body portion 33 of the chassis 30 are separate elements. In particular, the heat sink portions 31 are placed into the chassis 30, particularly into the body portion 33 of the chassis 30.

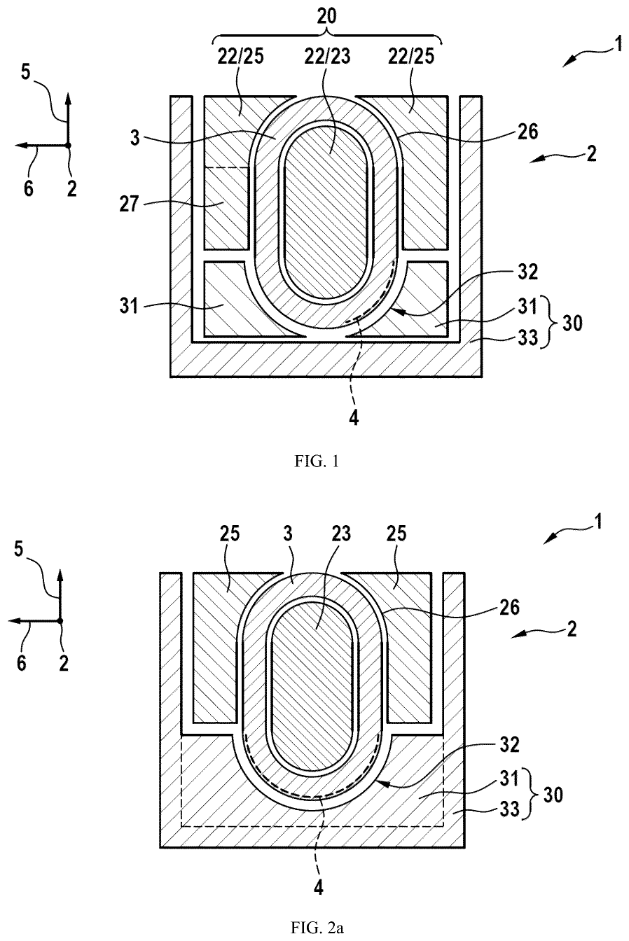

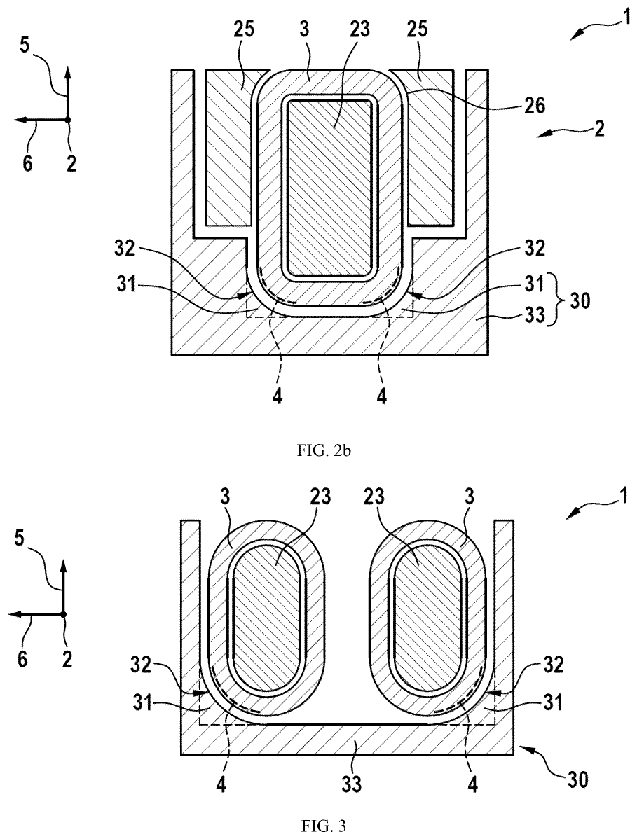

FIGS. 2a and 2b show schematic cross sectional views of a cooling assembly 1 according to a second embodiment of the present disclosure.

FIG. 2a, as a comparison with FIG. 1 shows, demonstrates heat sink portions 31 which are formed integrally, especially monolithically, with the body portion 33 of the chassis 30.

Therein, the chassis 30 comprises one heat sink portion 31 adjacent to the winding 3, particularly adjacent to the adjacent portion 4 of the winding 3. The heat sink portion 31 comprises a concave surface 32 with a half-circular shape. The corresponding adjacent portion 4 of the winding 3 also has a half-circular shape.

The winding leg portion 23 as well as the return leg portions 25 comprise the same shapes as in embodiment 1.

Thereby, due to the body portion 33 and the heat sink portion 31 being formed integrally, especially monolithically, with one another, a thermal resistance between the heat sink portion 31 and the body portion 33 of the chassis 30 is further reduced, thus improving cooling efficiency. Furthermore, the total volume of the cooling assembly 1 is also further reduced.

As can be taken from FIG. 2b, which shows a modification to the second embodiment, the winding 3 is not necessarily round, but may be rectangular, especially square.

In particular, as shown therein, the winding 3 comprises rounded edges. The heat sink portions 31 comprise the surfaces 32 which are shaped so as to correspond to the respectively adjacent portions 4 of the winding 3, i.e. the rounded edges thereof.

Furthermore, the return leg portions 25 are shaped rectangular. In particular, the return leg portions 25 may be completely rectangular, or as shown may comprise concave surfaces 26 which correspond in curvature to a curvature of the rounded edges of the adjacent winding 3. To accommodate the winding 3, the winding leg portion 23 also comprises a substantially rectangular shape with rounded edges.

FIG. 3 shows a schematic cross sectional view of a cooling assembly 1 according to a third embodiment of the present disclosure.

In the present embodiment, the magnetic core 20 comprises the body portion (not shown) and two leg portions 22. Furthermore, in the present embodiment, a winding 3 is disposed and wound around each of the leg portions 22, such that these leg portions 22 are winding leg portions 23.

The chassis 30 comprises the body portion 33 and two heat sink portions 31. Therein, each of the heat sink portions 31 is provided adjacent to one winding 3. In particular, each heat sink portion 31 comprises a quarter-circular concave surface 32 adjacent to a quarter-circular adjacent portion 4 of the respective winding 3.

In the present embodiment, the heat sink portions 31 are formed integrally, especially monolithically, with the body portion 33 of the chassis 30. Alternatively, these may also be formed separate from the body portion 33 and, for instance, be placed therein.

In particular, the heat sink portions 31 are formed in or disposed in corners of the body portion 33.

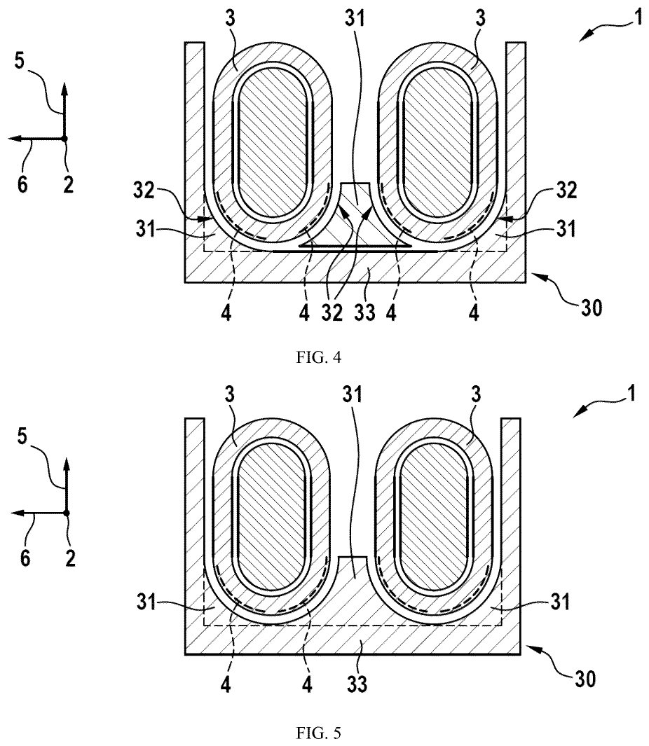

FIG. 4 shows a schematic cross sectional view of a cooling assembly 1 according to a fourth embodiment of the present disclosure.

In comparison to embodiment 3, the cooling assembly 1 of the present embodiment further comprises an additional heat sink portion 31 disposed between two adjacent winding leg portions 23. In particular, the additional heat sink portion 31 is provided between the adjacent winding leg portions 23 along a width direction 6 perpendicular to the height direction 5 and the leg extension direction 2. In other words, as can be taken from the cross sectional view of FIG. 4, the additional heat sink portion 31 is disposed so as to be sandwiched by the two adjacent winding leg portions 23.

Therein, said heat sink portion 31 disposed between the two winding leg portions 23 comprises two concave surfaces 32, each comprising a quarter-circular shape. Therein, each of the concave surfaces 32 corresponds in shape to the respective adjacent portion 4 of the winding 3.

Therefore, along the width direction 6 (from left to right in FIG. 4), the chassis 30 comprises a first heat sink portion 31 with a quarter-circular shaped concave surface 32, a second heat sink portion 31 with two quarter-circular concave surfaces 32, and a third heat sink portion 31 also with one quarter-circular concave surface 32. Herein, the two outer heat sink portions 31, which are provided respectively adjacent to one winding 3, are provided integrally with the body portion 33. On the other hand, the heat sink portion 31 provided between and adjacent to two windings 3, is provided separate from the body portion 33.

FIG. 5 shows a schematic cross sectional view of a cooling assembly 1 according to a fifth embodiment of the present disclosure.

Herein, as compared to embodiment 4, the heat sink portion 31 provided between the two windings 3, particularly between the two winding leg portions 23, is also formed integral with the body portion 33 in addition to the outer heat sink portions 31 of the chassis 30. Herein, all heat sink portions are formed integrally, especially formed monolithically, with the body portion 33 of the chassis 30.

Therefore, the chassis 30 of the present embodiment may also be considered as comprising two heat sink portions 31, each with a half-circular shaped concave surface 32.

FIG. 6 shows a schematic cross sectional view of a cooling assembly 1 according to a sixth embodiment of the present disclosure.

In the present embodiment, the magnetic core 20 comprises three leg portions 22. Therein, each of the leg portions 22 comprises a winding 3 wound around it, such that the magnetic core 20 of the present embodiment comprises three winding leg portions 23. Along the width direction 6, a middle leg portion 24 is defined as the leg portion 22, i.e. the winding leg portion 23, which is disposed between the other two outer leg portions 22.

Furthermore, as can be taken from FIG. 6, similar to embodiment 3, the chassis 30 of the present embodiment comprises two heat sink portions 31 respectively provided adjacent to one winding 3, in particular adjacent to an adjacent portion 4 of the respective winding 3. Said two heat sink portions 31 comprise quarter-circular shaped surfaces 32 and are formed integrally, especially monolithically, with the body portion 33 of the chassis 30.

Herein, no heat sink portion 31 is provided adjacent to the middle leg portion 24.

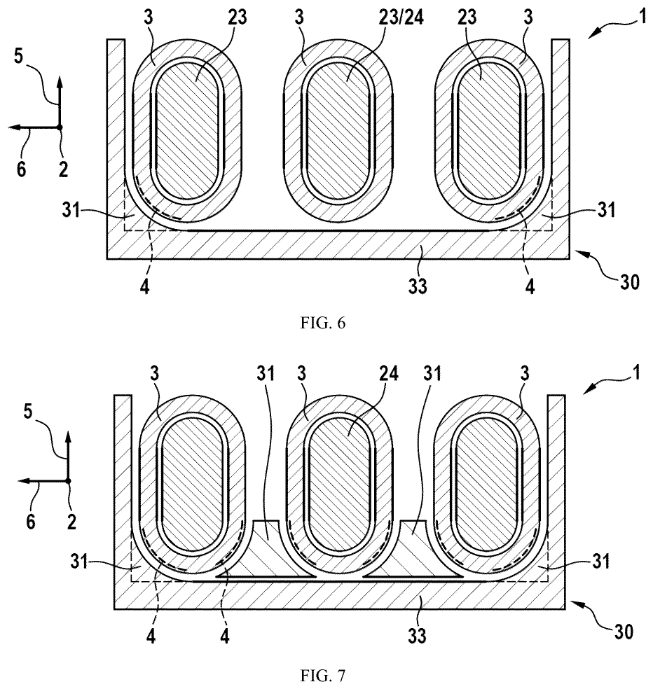

FIG. 7 shows a schematic cross sectional view of a cooling assembly 1 according to a seventh embodiment of the present disclosure.

Similar to the fourth embodiment shown in FIG. 4, the chassis 30 of the cooling assembly 1 according to the present embodiment comprises additional heat sink portions 31 provided respectively between two of the three winding leg portions 23. In other words, each of the additional heat sink portions 31 is disposed so as to be sandwiched by two winding leg portions 23 along the width direction 6. In particular, said additional heat sink portions 31 are provided both adjacent to the middle leg portion 24.

Therein, each of the heat sink portions 31 provided respectively adjacent to the middle leg portion 24 comprises two concave surfaces 32 which are each quarter-circular and which each correspond to a quarter-circular adjacent portion 4 of the respective winding 3 of the adjacent middle leg portion 24.

In total, the chassis 30 of the cooling assembly 1 of the present embodiment comprises four heat sink portions 31. Herein, the heat sink portions 31 provided between two winding leg portions 23, i.e. the heat sink portions 31 provided both adjacent to the middle leg portion 24, are provided separate from the body portion 33. In other words, said heat sink portions 31 are not formed integrally or monolithically with the body portion 33 of the chassis 30.

When considering the two heat sink portions 31 adjacent to the middle leg portion 24 together, they essentially comprise or define a half-circular shaped surface which corresponds to the half-circular adjacent portion 4 of the winding 3 of the middle leg portion 24 adjacent to both of said heat sink portions 31. Therefore, the chassis 30, in a modification to the present embodiment, comprises one heat sink portion 31 adjacent to the middle leg portion 24 comprising a half-circular shaped concave surface 32.

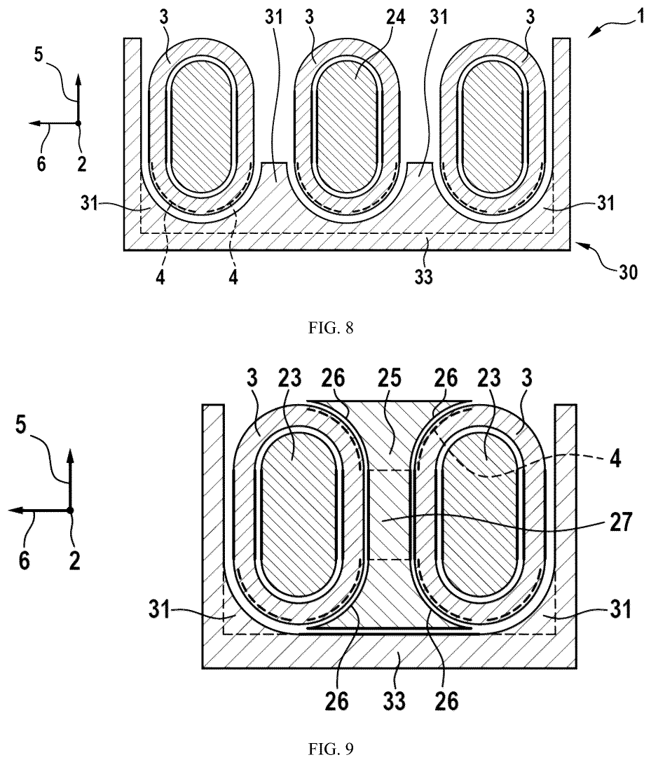

FIG. 8 shows a schematic cross sectional view of a cooling assembly 1 according to an eighth embodiment of the present disclosure.

In comparison to embodiment 7 shown in FIG. 7, the heat sink portions 31 provided respectively between two winding leg portions 23, i.e. said heat sink portions 31 adjacent to the middle leg portion 24, of the cooling assembly 1 of the present embodiment are formed integrally, especially monolithically, with the body portion 33 of the chassis 30.

Furthermore, as a comparison with FIG. 7 shows, when forming the heat sink portions 31 adjacent to the middle leg portion 24 integrally or monolithically with one another, these may be considered as one heat sink portion with a half-circular shaped surface 32.

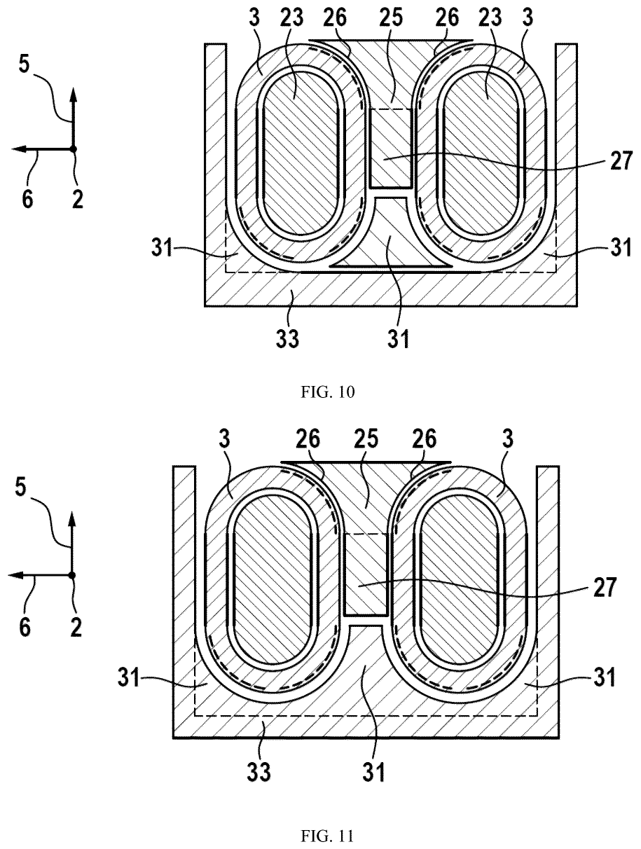

FIG. 9 shows a schematic cross sectional view of a cooling assembly 1 according to a ninth embodiment of the present disclosure.

As a comparison FIG. 9 with embodiment 3 shown in FIG. 3 shows, the cooling assembly 1 of the present embodiment comprises a magnetic core 20 with two winding leg portions 23 and a return leg portion 25. Herein, the return leg portion 25 is disposed, along the width direction 6, between the winding leg portions 23, in particular between the windings 3 of the respective winding leg portions 23. Herein, the return leg portion 25 comprises four concave surfaces 26, wherein each of the four concave surfaces 26 is quarter-circular and corresponds to an adjacent portion 4 of an adjacent winding 3. In particular, the return leg portion 25 comprises two concave surfaces 26 adjacent to one winding 3 and two further concave surfaces 26 adjacent to another winding 3. The concave surfaces 26 are connected via a straight portion 27 of the return leg portion 25. The return leg portion 25 thus substantially has, in the cross sectional view shown in FIG. 9, an “I” shape (capital “I” with cross bars).

FIG. 10 shows a schematic cross sectional view of a cooling assembly 1 according to a tenth embodiment of the present disclosure.

As a comparison of FIG. 10 with for example the seventh embodiment shown in FIG. 7 and the ninth embodiment shown in FIG. 9 shows, the cooling assembly 1 of the present embodiment comprises a magnetic core with two winding leg portions 23 and one return leg portion 25.

Herein, the return leg portion 25 comprises two concave surfaces 26 respectively adjacent to an adjacent winding 3 of a winding leg portion 23. The return leg portion 25 is disposed, along the width direction 6, between the two winding leg portions 23.

Furthermore, the chassis 30 of the present embodiment comprises one heat sink portion 31 also disposed along the width direction 6 between the two winding leg portions 23 and adjacent to the windings 3 thereof. Said heat sink portion 31 is disposed opposed to the return leg portion 25 and vice versa. In particular, the heat sink portion 31 disposed between the two winding leg portions 23 comprises two concave surfaces 32, each corresponding respectively to the shape of the adjacent portion 4 of the adjacent winding 3.

Furthermore, the heat sink portion 31 disposed between the two winding leg portions 23 is, in the present embodiment, formed separately from the body portion 33 of the chassis 30. The two heat sink portions 31 disposed respectively adjacent to one winding leg portion 23 are formed integrally, especially monolithically, with the body portion 33 of the chassis 30.

FIG. 11 shows a schematic cross sectional view of a cooling assembly 1 according to an eleventh embodiment of the present disclosure.

In the present embodiment, as compared to the tenth embodiment shown in FIG. 10, the heat sink portion 31 disposed between the two winding leg portions 23 is formed integrally, especially monolithically, with the body portion 33 of the chassis 30. In the present embodiment, all heat sink portions 31 are formed integrally, especially monolithically, with the body portion 33.

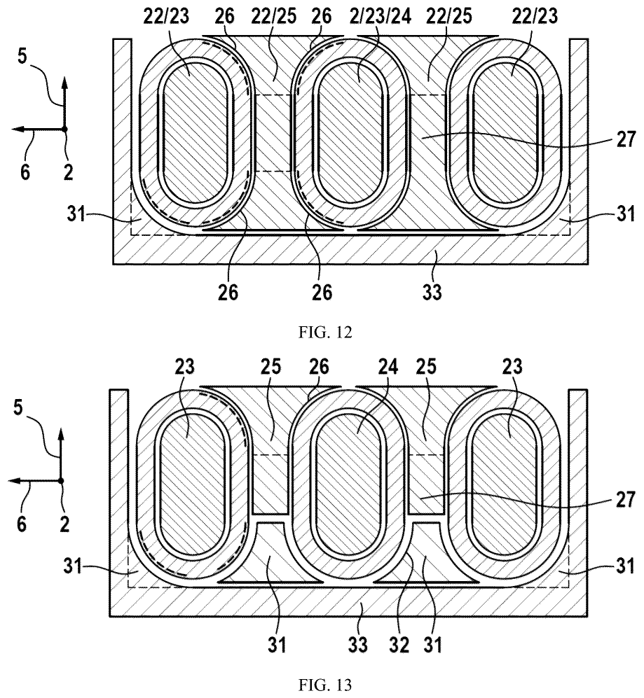

FIG. 12 shows a schematic cross sectional view of a cooling assembly 1 according to a twelfth embodiment of the present disclosure.

In the present embodiment, the cooling assembly 1 comprises a magnetic core 20 with a body portion (not shown) and five leg portions 22. In particular, the magnetic core 20 comprises three winding leg portions 23 and two return leg portions 25.

Therein, as also described with regard to the ninth embodiment shown in FIG. 9, each of the return leg portions 25 comprises four concave surfaces 26 and a straight portion 27 connecting the concave surfaces 26.

Each of the concave surfaces 26 is adjacent to one adjacent portion 4 of one winding 3 of an adjacent winding leg portion 23 and have a quarter-circular shape. In particular, each of the return leg portions 25 has an “I” shape. On the other hand, as also shown in FIG. 2b, the return leg portions 25 may generally have a bar shape or rectangular shape.

FIG. 13 shows a schematic cross sectional view of a cooling assembly 1 according to a thirteenth embodiment of the present disclosure.

The cooling assembly 1 of the present embodiment comprises three winding leg portions 23 and two return leg portions 25, wherein the two return leg portions 25 are respectively disposed between, along the width direction 6, two winding leg portions 23.

Herein, similar to embodiment ten shown in FIG. 10, each of the return leg portions 25 comprises two concave surfaces 26 respectively corresponding to one adjacent portion 4 of one winding 3 adjacent thereto.

Further herein, the chassis 30 comprises two heat sink portions 31, each of which is disposed between, along the width direction 6, two winding leg portions 23 and opposed to the return leg portions 25. Each of said two heat sink portions 31 comprises two concave surfaces 32 respectively corresponding to one adjacent portion 4 of one winding 3 adjacent thereto. Furthermore, said two heat sink portions 31 are formed separately, i.e. not integrally or monolithically, from the body portion 33 of the chassis 30.

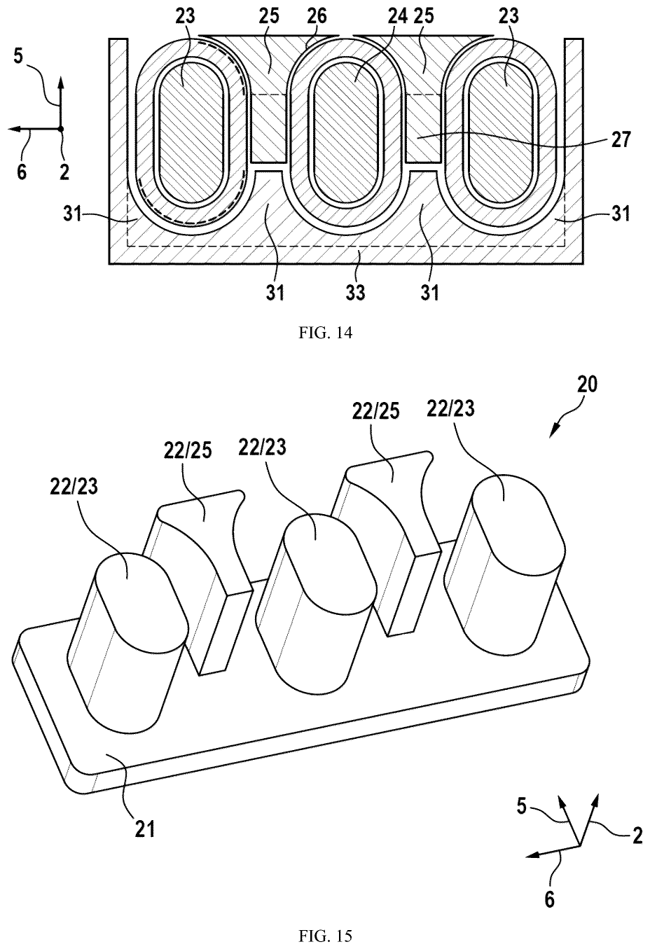

FIG. 14 shows a schematic cross sectional view of a cooling assembly 1 according to a fourteenth embodiment of the present disclosure.

In the present embodiment, the two heat sink portions 31 disposed between, along the width direction 6, two winding leg portions 23 are formed integrally, especially monolithically, with the body portion 33 of the chassis 30.

Furthermore, as also with embodiment one shown in FIG. 1, the return leg portions 25 of embodiments ten, eleven, thirteen, and fourteen also comprise a shape corresponding to the shape of adjacent portions 4 of adjacent windings 3. Furthermore, the shape of the return leg portions 25 is similar to that of the heat sink portions 31 provided between, along the width direction 6, the winding leg portions 23. Therein, the return leg portions 25 comprise the two concave surfaces 26 as well as the straight portion 27, wherein the straight portion 27 extends towards the opposing heat sink portion 31 of the chassis 30 along the height direction 5.

In one embodiment, gaps between elements of the cooling assembly 1 shown in the figures, especially between heat sink portions 31 or the body portion 33 of the chassis 30 and windings 3 or return leg portions 25 or between heat sink portions 31 and the body portion 33 of the chassis 30, are filled with potting material or thermal paste (not shown).

FIG. 15 shows a schematic cross sectional and perspective view of a magnetic core 20 of the cooling assembly 1 according to embodiment thirteen or fourteen of the present disclosure shown in FIGS. 13 and 14.

As can be taken from FIG. 15, the magnetic core 20 comprises the plurality of leg portions 22, particularly the winding leg portions 23 and the return leg portions 25 as well as the body portion 21. The body portion 21 connects the leg portions 22, which extend therefrom along the leg extension direction 2.

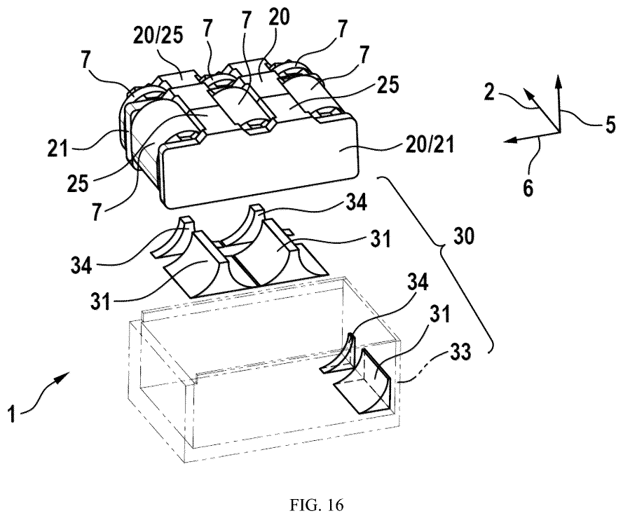

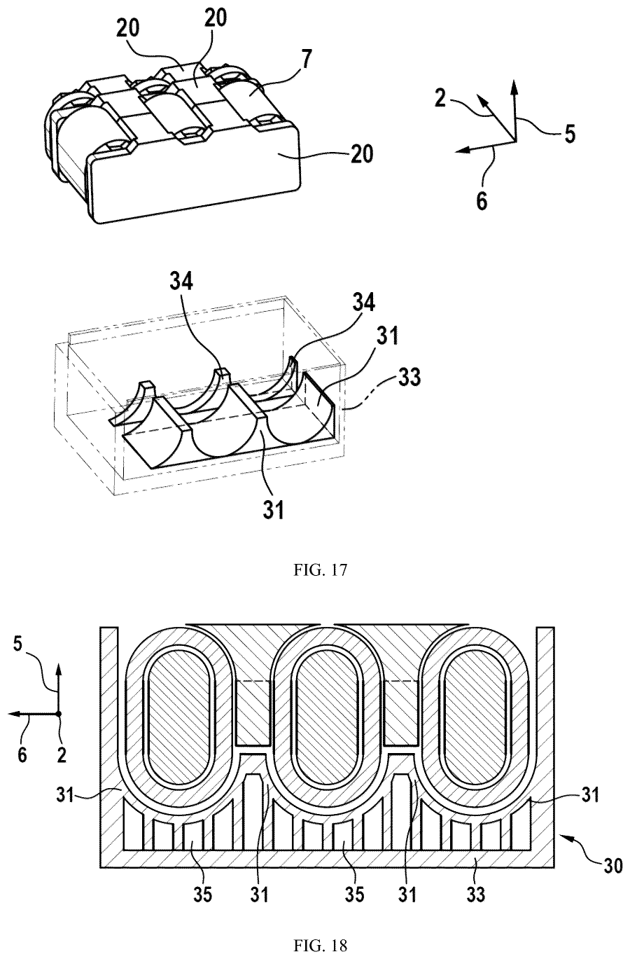

As will be explained also with regard to FIGS. 16 and 17, the cooling assembly 1 comprises more than one magnetic core 20, wherein two of the magnetic cores 20 oppose each other with regard to their leg extension directions 2. In other words, their body portions 21 oppose each other, with their respective leg portions 22 extending towards the leg portions 22 of the other magnetic core 20. Further yet, more than two magnetic cores 20 may be provided. Therein, one of the magnetic cores 20 (for example, a third magnetic core 20) may be arranged such that its leg portions 22 extend towards the body portion 21 of another magnetic core 20. Such an arrangement is commonly also referred to as “EE” arrangement or “EE∃”, “E∃”, “EE∃∃”, etc. arrangement of magnetic cores 20.

FIG. 16 shows a schematic exploded view of the cooling assembly 1 according to embodiment thirteen of the present disclosure.

In the exploded view shown in FIG. 16, the magnetic core 20 and the windings 3 are shown separated from the heat sink portions 31 and the body portion 33 of the chassis 30. More specifically, FIG. 16 shows the heat sink portions 31, which are disposed between adjacent windings 3, separated from the body portion 33, whereas the heat sink portions 31, which are disposed between the body portion 33 and an adjacent winding 3 (see also embodiments seven and thirteen) are shown within the body portion 33 of the chassis 30, as these are formed integrally therewith.

In the present embodiment, the cooling assembly 1 comprises a plurality of magnetic cores 20. More specifically, in the present embodiment, the cooling assembly 1 comprises three magnetic cores 20, especially in an “EE∃” arrangement thereof.

Each of the magnetic cores 20 comprises three winding leg portions 23 (not visible) and two return leg portions 25 connected to a body portion 20. Further, each of the magnetic cores 20 comprises one winding 3 (not visible) with a predetermined winding number wrapped around each winding leg portion. For example, with regard to the “EE∃” arrangement, the winding 3 of the top magnetic core 20 may form a choke, the winding 3 of the middle magnetic core 20 may form a primary side, and the winding 3 of the bottom magnetic core 20 may form a secondary side. The windings 3 are all covered with insulating material 7, and thus not visible in the present figure. The insulating material 7 is, for example, Kapton polyimide film.

Further, the chassis 30 comprises second heat sink portions 34 in addition to the heat sink portions 31, which are also disposed between adjacent windings 3 and between one adjacent winding 3 and the body portion 33 of the chassis 30. These second heat sink portions 34 comprise, along the leg extension direction 2, smaller dimensions so as to accommodate smaller windings 3 of the top magnetic core 20, i.e. the smaller choke windings 3.

FIG. 17 shows a schematic exploded view of the cooling assembly 1 according to embodiment fourteen of the present disclosure.

FIG. 17 also shows the cooling assembly comprising three magnetic cores 20, as explained above with regard to FIG. 16. Herein, the heat sink portions 31, 34 are formed integrally with, especially monolithically with, the body portion 33 of the chassis 30.

FIG. 18 shows a schematic cross sectional view of a cooling assembly 1 according to a fifteenth embodiment of the present disclosure.

Herein, as a comparison with for example FIG. 14 and the fourteenth embodiment shows, the chassis 30 comprises cooling channels 35 configured to allow passage of a cooling fluid (not shown) through them. Therein, the cooling channels 35 are formed especially in the heat sink portions 31 disposed between adjacent windings 3. In some embodiments, the cooling channels 35 are formed only in the heat sink portions 31.

The cooling channels 35 extend longitudinally, i.e. in cooling fluid flow direction, parallel to the leg extension direction 2.

Thereby, the chassis 30 is configured to provide efficient cooling of the windings 3 and the leg portions 22 of the magnetic core 20. Furthermore, due to the close proximity arrangement of the heat sink portions 31 to the windings 3, together with the cooling channels 35, cooling is achieved synergistically with much higher efficiency and effectivity.

In the foregoing, the term “formed integrally, especially monolithically” is used. Herein, the term “formed integrally” for example means formed separate from one another, but joined together in an especially non-detachable manner (especially not without destruction thereof), for instance welded together. The term “formed monolithically” refers to the two or more respective elements or portions being formed from one piece, for instance formed in one casting.

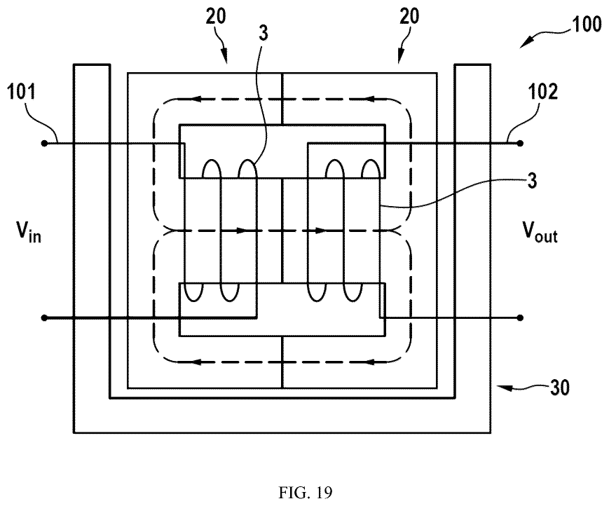

FIG. 19 shows a schematic diagram of an embodiment of a transformer 100 comprising the cooling assembly 1 according to any one of the embodiments.

The transformer 100 is an example of a magnetic component comprising the cooling assembly 1. Alternatively, the magnetic component may be a choke or an inductor.

Therein, the transformer 100 comprises one cooling assembly 1 which comprises two magnetic cores 20. The winding 3 of one magnetic core 20 corresponds to a primary side winding, and the winding 3 of the other magnetic core 20 corresponds to a secondary side winding of the transformer 100. Furthermore, as elucidated above with regard to FIGS. 16 and 17, the cooling assembly 1 may comprise an additional magnetic core 20, wherein the winding 3 thereof can be employed for example as a choke winding of the transformer 100. Herein, the chassis 30 is shown merely schematically for demonstration purposes.

The transformer 100 comprises an input side 101, into which an input voltage Vin is input, and an output side 102, from which an output voltage Vout is output.

Thereby, the present disclosure provides a transformer 100 which is compact in size and has a high efficiency.

In addition to the foregoing written explanations, it is explicitly referred to FIGS. 1 to 19, wherein the figures in detail show configuration examples of the present disclosure, and in particular show shapes of elements of the cooling assembly 1.

What is claimed is:

1. A cooling assembly for a magnetic component, comprising:
at least one magnetic core comprising a body portion and a plurality of leg portions extending from the body portion along a leg extension direction;
at least one winding wound around at least one of said leg portions as a winding leg portion of the magnetic core; and
a chassis configured to house the at least one magnetic core and the at least one winding,
wherein the chassis comprises at least one heat sink portion adjacent to at least one of the at least one winding, and the at least one heat sink portion comprises a shape, at least in cross-section perpendicular to the leg extension direction, corresponding at least to a shape of an adjacent portion of the adjacent at least one winding.

2. The cooling assembly according to claim 1, wherein the at least one heat sink portion comprises at least one concave surface corresponding respectively to the shape of the adjacent portion of the at least one winding adjacent to the at least one heat sink portion.

3. The cooling assembly according to claim 2, wherein the respective concave surface is half-circular or quarter-circular.

4. The cooling assembly according to claim 2, wherein the magnetic core comprises three leg portions, wherein at least a middle leg portion of the three leg portions is a winding leg portion and is rounded or comprises rounded edges.

5. The cooling assembly according to claim 4, wherein the chassis comprises two heat sink portions both adjacent to a winding of the middle leg portion and each of the two heat sink portions comprises a quarter-circular shaped surface so as to, taken together, substantially correspond to a shape of at least one of the adjacent portion of the winding or the middle leg portion.

6. The cooling assembly according to claim 4, wherein the chassis comprises one heat sink portion adjacent to a winding of the middle leg portion, and the heat sink portion comprises a half-circular shaped surface so as to substantially correspond to a shape of at least one of the adjacent portion of the winding or the middle leg portion.

7. The cooling assembly according to claim 1, wherein the at least one magnetic core comprises a plurality of winding leg portions, wherein at least one heat sink portion is disposed respectively between, perpendicular to the leg extension direction, two adjacent winding leg portions.

8. The cooling assembly according to claim 7, wherein the at least one heat sink portion comprises two concave surfaces, each comprising a quarter-circular shaped surface each corresponding to at least one of a respective adjacent winding leg portion or a respective adjacent portion of the respective adjacent winding leg portion.

9. The cooling assembly according to claim 1, wherein the chassis further comprises a body portion having a substantially rectangular shape.

10. The cooling assembly according to claim 9, wherein the body portion and the at least one heat sink portion are separate elements, or not monolithic with one another.

11. The cooling assembly according to claim 9, wherein the body portion and the at least one heat sink portion are formed integrally with one another, or formed monolithically with one another.

12. The cooling assembly according to claim 1, wherein at least the at least one heat sink portion comprised in the chassis comprises paramagnetic material.

13. The cooling assembly according to claim 1, wherein the at least one magnetic core comprises at least one return leg portion as one of the leg portions, and wherein at least one of the return leg portion comprises, in cross-section perpendicular to the leg extension direction, a shape corresponding to a shape of at least one of the winding leg portion or the winding adjacent to said return leg portion.

14. The cooling assembly according to claim 13, wherein the at least one of the return leg portion comprises, in the cross-section perpendicular to the leg extension direction, a concave surface and is arranged opposed, perpendicular to the leg extension direction, to the at least one heat sink portion of the chassis.

15. The cooling assembly according to claim 14, wherein said return leg portion comprising the concave surface is disposed between two winding leg portions and the respective adjacent winding portions of the two winding leg portions and comprises two concave surfaces.

16. The cooling assembly according to claim 14, wherein said return leg portion comprising the concave surface is disposed between two winding leg portions and the respective adjacent winding portions of the two winding leg portions and comprises four concave surfaces.

17. The cooling assembly according to claim 1, wherein the chassis comprises a plurality of cooling channels.

18. The cooling assembly according to claim 17, wherein the cooling channels are formed in the at least one heat sink portion of the chassis.

19. The cooling assembly according to claim 1, wherein the winding leg portion is circular, oval, stadium-shaped, or rectangular with rounded edges.

20. A magnetic component, comprising at least one cooling assembly according to claim 1.
